(19) United States
(12) Patent Application Publication
(10) Pub. No.: US 2025/0226119 A1
(43) Pub. Date: Jul. 10, 2025

(54) TECHNIQUES FOR ENHANCED CONFINEMENT IN MAGNETIC FUSION DEVICES

(71) Applicant: Board of Regents, The University of Texas System, Austin, TX (US)

(72) Inventors: Michael Thomas Kotschenreuther, Austin, TX (US); Swadesh Mahajan, Austin, TX (US); David R. Hatch, Austin, TX (US); Xing Liu, Austin, TX (US); Gabriele Merlo, Austin, TX (US)

(73) Assignee: Board of Regents, The University of Texas System, Austin, TX (US)

(21) Appl. No.: 18/850,784

(22) PCT Filed: Mar. 31, 2023
(86) PCT No.: PCT/US2023/017148

§ 371 Date: Sep. 25, 2024

Related U.S. Application Data
(60) Provisional application No. 63/326,659, filed on Apr. 1, 2022.

(51) Int. Cl. G21B 1/05; G21B 1/15

(52) U.S. Cl. CPC G21B 1/057; G21B 1/15; G21B 1/052; G21B 1/055

(57) ABSTRACT

Disclosed are techniques for initiating and sustaining a transport barrier within a magnetically confined plasma in a plasma fusion device. For a toroidal magnetic configuration, a characteristic region of the magnetic field can be established by generating a current within the plasma or by other means. The location of the characteristic region can be controlled to be suitably close to the interior walls of the plasma fusion device to allow a quantity of particles to be injected into the plasma at or inside the characteristic region. The quantity of particles can augment the density of the plasma and create a density gradient within the characteristic region, resulting in the formation of a transport barrier at or inside the characteristic region.

### CROSS-REFERENCE TO RELATED APPLICATION

This application claims priority to and the benefit of U.S. Provisional Patent Application No. 63/326,659, filed on Apr. 1, 2022, which is hereby incorporated by reference in its entirety.

### STATEMENT REGARDING FEDERALLY SPONSORED RESEARCH OR DEVELOPMENT

This invention was made with government support under Grant No. DE-FG02-04ER54742 awarded by the Department of Energy. The government has certain rights in the invention.

### FIELD

The present disclosure relates to magnetic confinement of plasmas. In particular, techniques are described for producing enhanced confinement of plasmas in devices used for fusion processes.

### BACKGROUND

Nuclear fusion continues to be a focal point for research into scalable energy sources. As the needs for clean, renewable energy increase worldwide, the desirability of nuclear fusion as a source of that energy also increases. To date, however, nuclear fusion technology has not achieved a sustained reaction sufficient to produce energy in excess of the energy required to operate the reactor.

In nuclear fusion, two nuclei (e.g., deuterium or tritium) combine to form one nucleus (e.g., helium), producing substantial energy. To achieve this reaction, a plasma or ionized gas must be confined and heated to several million degrees Celsius. The confinement is typically achieved using strong magnetic fields within a reactor, such that the magnetic confinement keeps the reacting plasma away from the reactor structure (e.g., chamber walls). The most successful reactor designs include toroidal vessels like tokamaks, in which a plasma is generated within a vacuum chamber and confined by a toroidal-shaped magnetic field.

Within a tokamak or similar toroidal fusion reactor, plasma confinement is accomplished by establishing a stable magnetic field within the reactor using several external field coils and by generating a current within the plasma. Because the plasma is ionized, its constituent particles are charged and will tend to gyrate tightly around the magnetic field lines in relatively small orbits. Essentially, the plasma sticks to the field lines but may move along the field lines easily. The field produced in the reactor has both toroidal (in the direction of the torus “ring”) and poloidal (in the direction “around” the torus) components, resulting in a helical magnetic field through the interior of the reactor. The configuration of this magnetic field therefore includes a region of nested toroidal magnetic surfaces containing magnetic field lines that are closed and do not touch the interior surfaces of the reactor vessel. The plasma can then be suspended in the closed magnetic region for long periods of time without contacting surfaces of the reactor. However, several processes allow for transport of plasma across the field lines and out of the confining region, resulting in a loss of energy and particles from the region where fusion occurs. Improving the confinement of the plasma by limiting the transport of energy and particles across the confining field is therefore an object of contemporaneous research.

### BRIEF SUMMARY

One aspect of a confined plasma is the presence of a “transport barrier,” a steep gradient in the density, temperature, and/or pressure of the plasma. Transport barriers are indicative of a weakening of one or more of the processes that result in instability of the confined plasma and transport of energy and particles out of the confinement region, including turbulent plasma flows. Depending on the configuration of the magnetic field, such weakening can be caused by velocity shear, magnetic shear, or similar mechanisms. Velocity shear has long been considered the primary mechanism for suppressing turbulent transport processes in a confined plasma. However, fusion operating regimes with low velocity shear are possible and likely crucial for further advances. Thus, methods to control the formation (e.g., location, duration, extent) of transport barriers is desirable.

Embodiments of the present disclosure relate to improving the confinement of a plasma in a fusion device. The plasma may be confined by a magnetic field that may be generated and manipulated with the application of currents both external to the plasma (e.g., in external coils) or internal to the plasma (e.g., a current in the plasma itself). A characteristic region of the confining magnetic field may be generated that has particular properties. By injecting particles into the plasma at or inside of the characteristic region of the magnetic field, a transport barrier may be initiated that can reduce the transport of plasma particles and energy out of the confinement region of the magnetic field, thereby improving the confinement of the plasma. This transport barrier may be sustained by subsequent injections of additional particles.

One embodiment is directed to a method that can include generating, in a plasma confinement device, a characteristic region of a magnetic field confining a plasma and injecting a quantity of particles into the plasma at or inside the characteristic region.

In various examples, the characteristic region may be defined by a region of negative magnetic shear, low magnetic shear, large Shafranov shift, a particular shape of magnetic surfaces of the magnetic field confining the plasma, where magnetic perturbations are resonant, or any combination of these defining features. In some examples, the characteristic region may be generated by generating a current in the plasma that is parallel with the magnetic field at the characteristic region. Injecting the quantity of particles at or inside the characteristic region can generate a transport barrier, according to certain examples. The transport barrier may be characterized by a large pressure gradient of the plasma. Resonant magnetic perturbations induce transport of particles and heat, and causing them in the characteristic region can help to control the pressure gradient there. In some embodiments, this can be useful in order to increase the width of the transport barrier, and also to avoid magnetohydrodynamic instabilities. The transport barrier may be generated at a position about 70% of a minor radius of the plasma confinement device. In some examples, the transport barrier may be generated at a position about 80% of the minor radius or about 90% of the minor radius of the plasma confinement device. In some examples, the quantity of particles can include fusion fuel particles, including deuterium and/or tritium. In some examples, the quantity of particles can include impurity particles, including carbon, silicon, a noble gas, or an element with atomic number Z less than 21.

Another embodiment is directed to a second method that can include generating a characteristic region of a magnetic field confining a plasma, injecting a first quantity of particles into the plasma at or inside the characteristic region, and injecting a second quantity of particles into the plasma at or inside the characteristic region. The first quantity of particles may be injected at a first time and for a first duration, while the second quantity of particles may be injected at a second time and for a second duration.

In various examples, the characteristic region may be defined by a region of negative magnetic shear, low magnetic shear, large Shafranov shift, a particular shape of magnetic surfaces of the magnetic field confining the plasma, a position where magnetic perturbations are resonant, or any combination of these defining features. In some examples, the first quantity of particles can include at least a portion of impurity particles. In several examples, the second quantity of particles can include impurity particles, fusion fuel particles, and/or a mixture of impurity particles and fusion fuel particles. Both the first quantity of particles and the second quantity of particles may be injected at time averaged rates, according to certain examples. The time averaged rate of particle injection for the second quantity of particles may be less than the time averaged rate of injection for the first quantity of particles. In some examples, the first quantity of particles can include a first fraction of fusion fuel particles and the second quantity of particles can include a second fraction of fusion fuel particles, where the second fraction is greater than the first fraction.

Still another embodiment is directed to a system that can include a plasma confinement device, a particle injector, and a controller. The controller may have one or more processors and one or more memories storing computer-executable instructions that, when executed with the one or more processors, cause the system to adjust a current of a plasma confined by a magnetic field within the plasma confinement device to generate a characteristic region of the magnetic field, and inject, using the particle injector, a quantity of particles into the plasma at or inside the characteristic region, thereby forming a transport barrier at or inside the characteristic region.

In some examples, the plasma confinement device may be a tokamak device, a stellarator, or a toroidal pinch device. In several examples, the particle injector can be configured to inject the quantity of particles as high velocity pellets, which may include a portion of cryogenically frozen pellets, or as a magnetically confined plasma, which may be a compact toroid. In some examples, the quantity of particles may be a first quantity of particles injected at a first time and for a first duration. The one or more memories of the controller can store additional instructions that, when executed, cause the system to further inject, using the particle injector, a second quantity of particles at a second time and for a second duration, the second quantity of particles sustaining the transport barrier for the second duration. The first quantity of particles can include impurity particles and the second quantity of particles can include fusion fuel particles or a mixture of fusion fuel particles and impurity particles, according to certain examples. In some examples, the first quantity of particles can include a first fraction of fusion fuel particles and the second quantity of particles can include a second fraction of fusion fuel particles, where the second fraction is greater than the first fraction. In some examples, the time averaged rate of particle injection for the second quantity of particles may be less than the time averaged rate of injection for the first quantity of particles.

### BRIEF DESCRIPTION OF THE DRAWINGS

FIGS. 1A and 1B are cross sectional schematics of an example plasma confinement system, according to several embodiments.

FIG. 2 is a sectional view of a confined plasma having a characteristic region for the formation of a transport barrier, according to at least one embodiment.

FIG. 3 is a simplified diagram of a toroidal magnetic configuration with a characteristic region for the formation of a transport barrier, according to at least one embodiment.

FIG. 4 is a simplified diagram of a plasma confinement system for generating a transport barrier at a characteristic region of a confining magnetic field, according to at least one embodiment.

FIG. 5 is a plot depicting example operating modes of a plasma confinement device.

FIG. 6 is another plot depicting example temperature gradients for a confined plasma exhibiting a generated transport barrier, according to at least one embodiment.

FIG. 7 is a simplified diagram of an example method for generating a characteristic region in the magnetic field confining a plasma, according to at least one embodiment.

FIG. 8 is another simplified diagram of an example method for initiating a transport barrier with a first quantity of particles and sustaining the transport barrier with a second quantity of particles, according to at least one embodiment.

FIG. 9 is another simplified diagram of an example method for generating a transport barrier at a characteristic region of a magnetically confined plasma, according to at least one embodiment.

### DETAILED DESCRIPTION

The techniques described herein relate to systems and methods for controlling the creation of transport barriers (TBs) within a magnetically confined plasma. In particular, the techniques include manipulating the confining magnetic configuration to establish a region of the field with a specific characteristic (e.g., negative magnetic shear or reduced magnetic shear), then injecting a quantity of particles (e.g., fusion fuel particles) at or inside the characteristic region to form the transport barrier. The increase in density from the injected particles can result in the formation of a transport barrier (e.g., a steep radial gradient in the plasma temperature, density, and/or pressure). The transport barrier may be formed at or near the characteristic region. By controlling where the characteristic region is formed, the location of the resulting transport barrier can also be controlled, thereby allowing a TB to be formed at an advantageous location for confinement of the plasma.

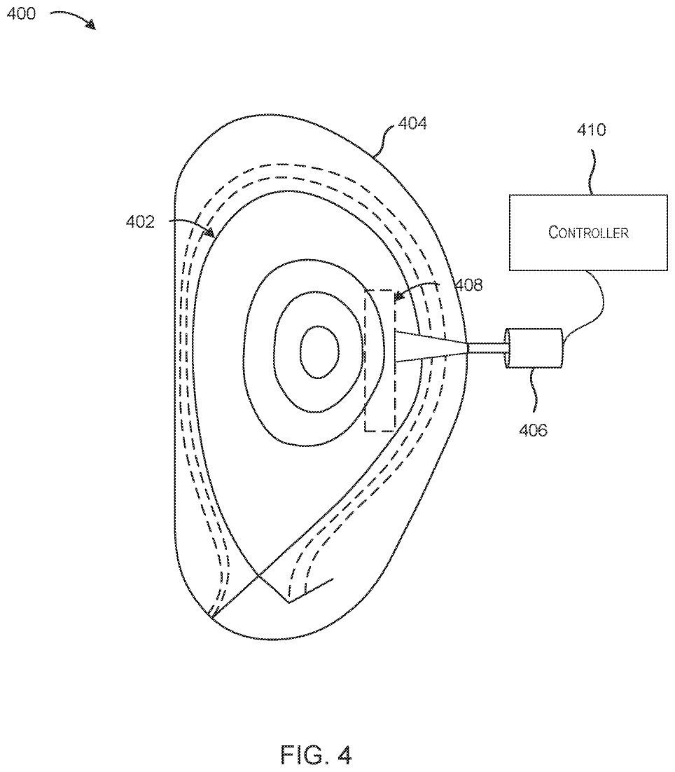

Current plasma confinement devices used for fusion applications typically operate in one of a number of modes of confinement that result in the formation of TBs in various locations. As a particular example (with reference to FIG. 5), tokamaks (and stellarators) may operate in a high-confinement mode (H-mode, e.g., H-mode 504 of FIG. 5) that results in an internal TB (ITB, e.g., ITB 508, a TB located away from the interior wall of the device) as well as an edge TB (e.g., edge TB 510). The H-mode may be distinguished from a low-confinement mode (L-mode, e.g., L-Mode 506) that exists before the confined plasma is strongly heated. The transition from L-mode to H-mode is generally thought to result from the suppression of turbulence in the plasma. The ITB in the H-mode may define an interior “core” region of the plasma (e.g., core region 502) where sufficient temperature and density are achieved to support the fusion process. The edge TB in the H-mode is typically close to the interior wall of the reactor, where the magnetic field lines are open and particle flux is not confined and may impinge the walls and other structures.

As mentioned above, the formation of a TB may occur when certain plasma instabilities (e.g., turbulent plasma processes) are weakened or suppressed. These instabilities may be characterized by one or more modes of the system, including the ion temperature gradient (ITG) mode, electron temperature gradient, the trapped electron mode (TEM) mode, and/or couplings between one or more modes. Generally, the plasma instabilities result from “drifts” of particles across the magnetic field lines. Several drifts are characteristic in a plasma and relate to both the geometry of the magnetic field (e.g., the gradient, the curvature, etc.) and the kinetics of the charged particles (ions and electrons). The drifts can include the \vec{E}× \vec{B} drift, grad-B (∇B) drift, and the curvature drift. Using the ITG mode as an example, the grad-B drift and the curvature drift is the mechanism by which the ITG mode drives plasma instability: the grad-B drift velocity is

$${v}_{D} = \frac{{KE}_{⊥}}{qB} \frac{\vec{B} \times ∇ B}{{B}^{2}} ,$$

which depends on the kinetic energy of the particles, which in turn depends on the temperature of the particles. If the ITG is aligned with ∇B, then particles in the hotter region of the ITG will drift more than particles in the colder region, creating charge separation and a resulting electric field that will drive an \vec{E}× \vec{B} drift that will enlarge perturbations to the ITG. Suppression of this turbulent process can occur from shear in the \vec{E}× \vec{B} flow.

Velocity shears, however, scale poorly for larger geometries, so that the suppression of turbulent processes becomes weaker. Thus, velocity shears are unlikely to be sufficient to provide appropriate confinement for plasmas in larger reactors.

Suppression of turbulent transport processes may also occur in presence of magnetic shear. For a toroidal magnetic configuration (e.g., in a tokamak), the magnetic shear of the field may be defined as the radial gradient of the “rotational transform” 1, which is a measure of the number of poloidal transits a field line makes for each toroidal transit of the line (in essence, how many helical twists a field line makes as it goes around the torus). Mathematically, the magnetic

$$s = - \frac{r}{ι} \frac{d ι}{dr} ,$$

shear is given as where r is the radial coordinate from the center of toroidal cross-section of the torus. Negative values of the magnetic shear are possible in regions where the radial gradient of t is large (e.g., greater poloidal “twist” for increasing r), which can be generated with a current in the plasma parallel to the magnetic field in that region. Negative magnetic shear is associated with suppression of instabilities due to curvature of the magnetic field (e.g., the curvature drift). In some examples, low magnetic shear might be a region where s<0.3. More generally, the region of curvature instabilities may be characterized by a length parameter, such that the length parameter is small (e.g., smaller than a characteristic distance) along the magnetic field. In other words, the destabilizing curvature drift velocity has a destabilizing sign, for which the curvature drift drives growth in perturbations of steep gradients in the plasma, over a distance of the length parameter.

Suppression of turbulent transport processes may also occur in the presence of a large Shafranov shift. The Shafranov shift is the outward radial displacement of the center of flux surfaces with minor radius r, induced by plasma pressure or the hoop force. For the purposes of this disclosure, the Shafranov shift can be approximately defined by the parameter α=

$$R {q}^{2} ( \frac{dp}{dr} ) / ( \frac{{B}^{2}}{{μ}_{0}} ) ,$$

where MKSA units are used, where

$$q = \frac{1}{ι}$$

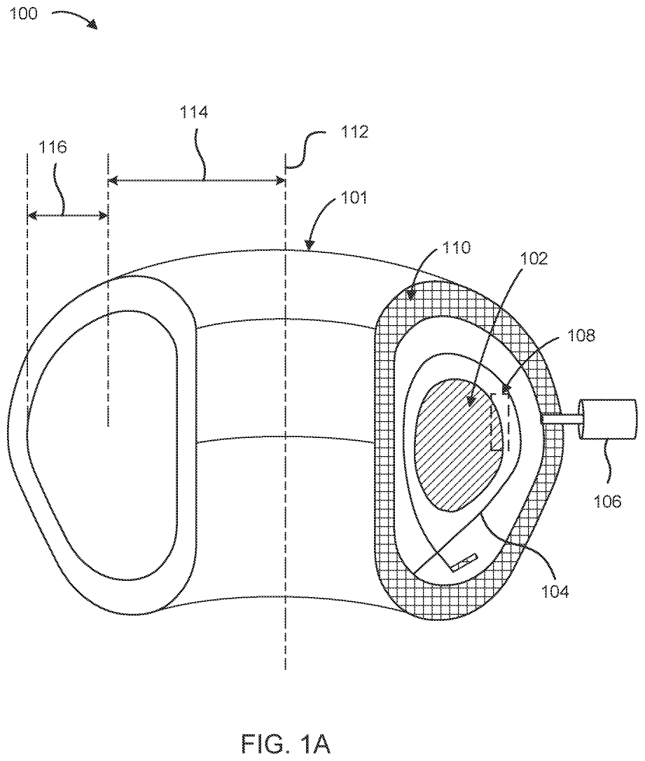

is the inverse of the rotational transform, where R is the distance from an approximate axis of rotation 112 for the magnetic geometry in FIG. 1, where B is the total magnetic field strength, and μ₀ is the permeability of free space (=4π×10⁻⁷ newtons per ampere squared). As one example, a large value of the Shafronov shift might be α>3. A large Shafranov shift and a negative or reduced magnetic shear can work independently to reduce the turbulence but can also work together and give more reduction.

Current within the confined plasma may be induced with external coils (e.g., a central solenoid in a tokamak) by supplying a varying current. For example, a central solenoid may be used to induce a toroidal current in the plasma by applying a linear ramp current to the solenoid. By configuring the geometry of the external coils and the supply current, currents within a confined plasma may be generated at particular locations with orientations primarily aligned with the magnetic field at those locations. The induced currents may then generate the appropriate magnetic shear to create a characteristic region suitable for initiating and sustaining an ITB.

A TB may be initiated in a number of ways. As discussed above for the case of an H-mode confined plasma, a TB may form when a critical heating threshold is exceeded in the core plasma. The initial plasma may be generated using radio frequency discharge, microwave discharge, neutral beam heating, or the like. Once ionized and confined, the plasma can be heated by ohmic heating (from an induced current), adiabatically by compressing the confining magnetic field, neutral beam injection, and/or combinations of these and similar mechanisms.

Another method for initiating a TB, and the principle of the present disclosure, is with injected particles into a confined plasma. Particles (e.g., pellets of fusion fuel, pellets of impurity atoms) may be injected into the confined plasma to increase a local density gradient. Due to conservation constraints on the plasma system, such an injection into the confined plasma can initiate a sustainable TB. The TB may be formed at a location where the magnetic configuration of the confining magnetic field possesses a particular characteristic (e.g., negative magnetic shear, large positive magnetic shear, reduced magnetic shear, large Shafranov shift, etc.).

Because of the dynamical processes within the confined plasma, injecting particles (e.g., pellets) deep into the core region may not be feasible. For example, a pellet fired from outside the confinement region with velocity 1 km/s may only penetrate 20 cm into the confinement zone before ionizing and disintegrating. Thus, creating a characteristic region of the magnetic field too close to the center of the confinement zone will prevent the deposition of the injected particles at that region. Similarly, ITBs associated with typical operating modes of fusion reactors form too far from the exterior of the confined plasma to allow a particle injection to sustain the mode after formation. Moreover, the edge TB of the H-mode operating regime creates significant instabilities near the edge of the confinement region, wherein edge TB repeatedly weakens and allows plasma particles and energy to escape into the open field region of the reactor and deposit substantial energy into the walls and equipment of the vessel. The techniques of the present disclosure solve many of these issues by allowing for the creation of a characteristic magnetic region sufficiently close to the exterior of the confined plasma region to allow injected particles to both initiate a TB and sustain the TB.

The basis for the techniques disclosed herein is the recognition of a fundamental physics constraint on the dynamics of the plasma processes occurring in the reactor. Typically, the presence of large gradients like a TB would be a source of substantial free energy for the system and thereby drive the various instabilities that reduce or remove the gradients. As discussed above, however, TBs may form in a magnetically confined plasma when turbulent processes are suppressed. The primary constraint that allows for the suppression of the turbulent processes is that turbulent transport is ambipolar, so that the net charge flux due to turbulence in the plasma is zero (i.e., turbulent processes do not generate fluxes of ions unbalanced from fluxes of electrons). Because steep density gradients tend to drive an ion charge flux much more than an electron charge flux, the flux constraint can prevent strong instabilities from arising, because the transport from such instabilities cannot satisfy the condition of ambipolar transport. Instabilities cannot arise if they do not satisfy the necessary condition of ambipolar transport. If the ambipolarity constraint cannot be satisfied, then the free energy in the steep gradients of density and temperature are unavailable to instabilities. The turbulence is thus suppressed. Coupling this observation with the creation of particular regions of the confining magnetic geometry allow the injected particles to create sustainable gradients of both temperature and density at the particular region, forming a TB with beneficial properties for fusion reactions at large scale.

The present techniques offer numerous advantages over the current methods known in the state of the art. By controlling the generation of the characteristic region of the magnetic geometry, the characteristic region may be formed at a suitable location to allow the injection of particles into the region. This location can allow for the creation of a TB further from the center of the confinement region, creating a larger, stable core plasma region where fusion reactions can occur, resulting in improved fusion output and better confinement of larger-scale reactors. The characteristic region may also be formed at a suitable distance from the interior walls of the reactor vessel, thereby allowing the formation of the TB further from the edge region and limiting or eliminating the presence of edge localized modes and other modes that strongly interact with the physical equipment (e.g., walls, diverters, limiters, probes, etc.) of the reactor vessel. Since the resulting TB is further from the center of the confinement region, additional particles can be injected into the region past the TB to sustain the TB (e.g., sustain the density gradient), without degrading or destroying the TB.

Turning now to the figures, FIG. 1A is cross sectional schematic of an example plasma confinement system 100, according to at least one embodiment. The plasma confinement system 100 can include a plasma confinement device 101. The plasma confinement device 101 may be a toroidal device with axial symmetry about a central axis 112. As depicted in FIG. 1A, the plasma confinement device 101 may have a D-shaped cross section, similar to many tokamak designs. Other cross-sectional profiles are possible, including circular, elliptical, and the like. Additionally, other configurations of toroidal confinement device are contemplated, including stellarators, spheromaks, toroidal pinch devices (e.g., reverse field pinch), and the like.

The plasma confinement device 101 can have a wall 110 providing a physical boundary for the interior of the device. The interior volume may be a vacuum chamber suitable for supporting the ionized gas or plasma necessary for fusion. The plasma confinement device 101 may have a major radius 114 defined from the central axis 112 to the center of the interior of the torus. Similarly, the interior may have a minor radius 116 defined from the center of the interior to the interior surface of the wall 110.

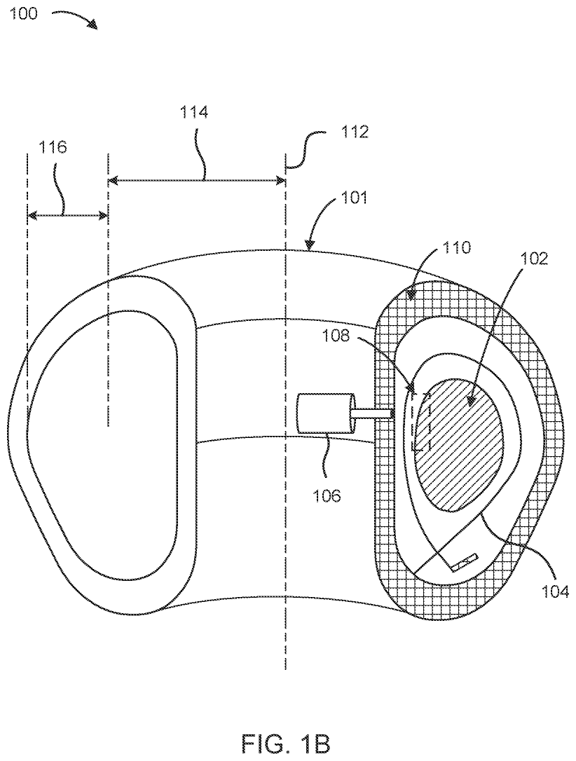

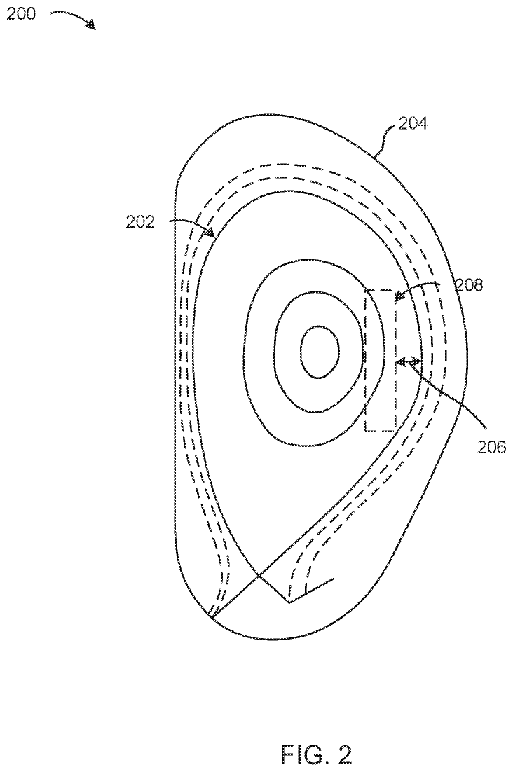

A suitable magnetic field may be generated within the volume to suspend and confine a plasma within the plasma confinement device 101. The magnetic field may be generated by one or more external coils (not shown in FIG. 1A), including a central solenoid, one or more toroidal field coils, one or more poloidal field coils, and/or one or more additional coils to generate magnetic fields within the interior of the plasma confinement device 101. In some embodiments, one or more of the external coils may be configured to inductively couple with the suspended plasma to drive a current within the plasma. The plasma current may then generate a corresponding magnetic field within the plasma confinement device 101. For example, a central solenoid may be used to generate a varying external field that couples to the toroidally confined plasma and generates a toroidal current in the plasma. The toroidal current may then generate a poloidal magnetic field within the plasma confinement device. This poloidal magnetic field may then be a poloidal component of the resulting magnetic field that suspends and confines the plasma. Additional details about the magnetic geometry in a toroidal confinement device are provided below with respect to FIGS. 2 and 3. In yet other embodiments, external coils can create resonant magnetic perturbations, that is, magnetic perturbations that are resonant in the plasma.

For a plasma confinement device 101 with a toroidal configuration, the magnetic field generated in the interior may be divided into two regions corresponding to the nature of the magnetic flux. The two regions may be separated by a separatrix 104, which defines a boundary between the region of closed magnetic flux (e.g., closed magnetic field lines) enclosed by the separatrix 104, and a region of open magnetic flux (e.g., open magnetic field lines) exterior to the separatrix 104. Additional details of the interior magnetic field geometry are provided below with respect to FIG. 2.

The interior of the closed field region defined by separatrix 104 may be a core plasma region 102 in which the temperature and pressure may reach sufficiently high values to initiate a fusion reaction. The closed magnetic field lines form surfaces called magnetic surfaces. The heating of the core plasma region 102 may be achieved using ohmic heating (e.g., induced electric currents in the plasma), RF discharge, microwave discharge, adiabatic compression (e.g., compressing the confining magnetic field), neutral beam injection, and other similar methods. Because particles and energy may diffuse across the field lines via transport processes (e.g., turbulent transport), maintaining a strong confinement by limiting the transport processes may be necessary to keep the plasma at a high enough temperature to maintain a fusion reaction for long periods.

To improve the plasma confinement in the core plasma region 102, a transport barrier (TB) may be generated by the plasma confinement system 100. A particle injector 106 may be configured to inject a quantity of particles into the confined plasma at, or inside of, a characteristic region 108. The characteristic region 108 may be a region of the magnetic field confining the plasma having a geometry or other characteristic parameter suitable for establishing a TB. In some embodiments, the characteristic region 108 may be a region of low or negative magnetic shear in the magnetic field. In other embodiments, the characteristic region 108 may be a region of strong Shafranov shift. In other embodiments, the characteristic region may be a region with a particular shape of the magnetic surfaces of the magnetic field that is conducive to the formation of a transport barrier. In yet other embodiments, the characteristic region could be where magnetic perturbations are resonant. Although depicted in FIG. 1A as a rectangle, the characteristic region 108 may be radially defined, such that it forms a radial layer approximately aligned with the flux surfaces of the confined magnetic field. In some embodiments, the characteristic region 108 may be localized on the outboard side (e.g., further from the central axis 112) of the core plasma region 102.

FIG. 1B depicts another example of the plasma confinement system 100. The characteristic region 108 can be located on the inboard side of the plasma confinement device 101 (e.g., closer to the central axis 112). Similarly, the particle injector 106 can also be on the inboard side of the plasma confinement device.

Establishing the characteristic region 108 can include generating a current within the confined plasma. The current may be parallel to the magnetic field at the location where the current is generated, thereby generating a region of magnetic shear (e.g., negative magnetic shear, reduced magnetic shear, etc.) at the characteristic region 108. In some embodiments, the current that creates the characteristic region 108 may not pass through the characteristic region (e.g., the generated current density in the characteristic region is small). The current may be generated by one or more external coils, which can change the shape of the magnetic surfaces. In other embodiments, the characteristic region can have a strong Shafranov shift.

Once the characteristic region 108 is established, the particle injector 106 may be used to inject a quantity of particles at or inside the characteristic region. By “inside” the characteristic region 108, it is meant more deeply inside the core plasma 102, closer to the center of the core plasma, where the minor radius 116 is small. The quantity of particles may increase the density at and/or inside the characteristic region and form a density gradient within the characteristic region 108. As discussed above, the density gradient may form a TB via physical constraints within the confined plasma system. In some embodiments, the particle injector 106 may be configured to inject a second quantity of particles into the characteristic region 108 after the TB is established. This second quantity of particles may sustain the transport barrier for a longer duration than the self-organizing processes of the confined plasma may typically allow. In various embodiments, the particle injector 106 may be configured to inject the quantity of particles as pellets (e.g., cryogenically frozen pellets), particle beams, compact magnetically confined plasmas (e.g., small spheromak guns), gas puff, or other similar delivery methods. The particles used to initiate the TB may be different from the particles used to sustain the TB. For example, the particles used to initiate the TB may include some proportion of “impurity” particles, while the particles used to sustain the TB may be entirely fusion fuel particles, or have only a smaller proportion of impurity particles. Impurity particles with higher atomic number (higher Z) may increase the density gradient and lead to a stronger constraint on the diffusion within the confined plasma, and so may be more effective at initiating a TB.

For nuclear fusion reactors, fusion fuels are primarily deuterium and/or tritium, which may be the primary constituents of the confined plasma. Sometimes, as in the case of the fusion device ITER, there is a testing phase of operation where the plasma primarily consists of helium or protons. These are not strictly fusion fuels; however, they are intended to play the role of fusion fuels for the purpose of testing the plasma dynamics. Therefore, as used in this disclosure, helium and protons may also be considered fusion fuels, since they play the same role as fusion fuel for proposes of testing the plasma behavior, and TB formation is an important aspect of plasma behavior that may be tested in this phase of operation. Impurity particles may be any other species of ions other than the fusion fuel, or the ions that are playing the role of fusion fuel, including, but not limited to, lithium, neon, carbon, nitrogen, silicon, and other elements with atomic number of Z=3 or Z>3. The quantity of particles injected by particle injector 106 may include fusion fuel particles, impurity particles, or any combination of fusion fuel particles and impurity particles. In some embodiments, the composition of the quantity of particles may change over time according to the type of particles desired at or inside the characteristic region to sustain the TB and assist the confined fusion process.

FIG. 2 is a sectional view of a confined plasma in a plasma confinement device 200 having a characteristic region 208 for the formation of a transport barrier, according to at least one embodiment. The plasma confinement device 200 may be an example of plasma confinement device 101 of FIG. 1A. The plasma confinement device 200 may have an interior wall 204 defining an interior volume of the device in which a confining magnetic field may be established.

As described above, the magnetic field may be characterized by a separatrix 202 (an example of separatrix 104 of FIG. 1A). Open magnetic field lines (e.g., the dashed lines of FIG. 2) may terminate on surfaces of the plasma confinement device 200, including the interior wall 204, diverters, limiters, or other equipment. Closed field lines inside the separatrix may form toroidally nested surfaces of constant magnetic flux, which are called magnetic surfaces. The magnetic surfaces (e.g., the solid lines interior to separatrix 202), have field lines that typically “twist” poloidally as they transit toroidally along the plasma confinement device interior. Because the plasma particles are ionized, the particles will tend to be bound to (“stick”) to the closed field lines in a small gyro orbit, such that the particles may move relatively freely along the field lines but relatively slowly across the field lines.

A characteristic region 208 of the magnetic field may be generated at a location within the interior of the plasma confinement device 200. The characteristic region 208 may be an example of characteristic region 108 described above with respect to FIG. 1A. As with characteristic region 108, characteristic region 208 may have a radial orientation and shape such that characteristic region 208 generally aligns with the surfaces of magnetic flux in the closed field region. In some embodiments, the characteristic region 208 may be a region of low, reduced, or negative magnetic shear. Generating the characteristic region 208 can include generating a current in the plasma parallel to the magnetic field at or near the characteristic region 208. In some other embodiments, the characteristic region may have a large Shafranov shift. In yet other embodiments, the characteristic region may be a region with a particular shape of the magnetic surfaces of the magnetic field that is conducive to the formation of a transport barrier. In yet other embodiments, the characteristic region 108 can be where magnetic perturbations are resonant.

The characteristic region 208 may be generated at a distance 206 from the separatrix 202 of the plasma confinement device 200. In some embodiments, the distance 206 may be 10% of the radial distance (e.g., minor radius 116 of FIG. 1A) from the center of the toroidal cross section of the plasma confinement device 200. Thus, the characteristic region 208 may be formed close to the separatrix 202 but not close enough for a resulting transport barrier to result in instabilities (e.g., edge localized modes) near the edge of the plasma confinement region. The distance value of 10% from the separatrix 202 is provided as an example; other locations for the characteristic region 208 are contemplated and would provide a suitable location for forming a transport barrier in accordance with this disclosure.

FIG. 3 is a simplified diagram of a toroidal magnetic configuration 300 with a characteristic region 308 for the formation of a transport barrier, according to at least one embodiment. The characteristic region 308 may be an example of characteristic region 208 of FIG. 2 or characteristic region 108 of FIG. 1A.

In the simplified geometry of FIG. 3, the magnetic confinement region 302 includes poloidal magnetic field 304 along the torus, with a toroidal magnetic field 306. The resulting total magnetic field therefore includes helical magnetic field lines that twist poloidally in the direction of the poloidal field 304 while following the toroidal magnetic field 306. The poloidal magnetic field 304 may be generated by an induced current in the plasma that is parallel to the toroidal magnetic field 306.

To generate the characteristic region 308, a current 310 may be generated in the magnetic confinement region 302. The current 310 may parallel or substantially parallel to the magnetic field in the characteristic region 308. The current 310 may generate another contributing component to the magnetic field (e.g., additional poloidal field) at the characteristic region. For example, the current 310 may generate additional poloidal field such that the gradient of the rotational transform becomes larger and the resulting magnetic shear in the characteristic region becomes negative.

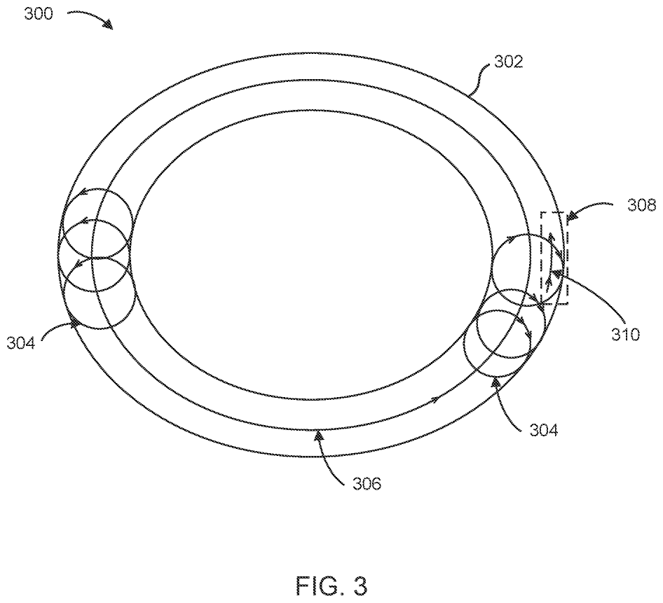

FIG. 4 is a simplified diagram of a plasma confinement system 400 for generating a transport barrier at a characteristic region 408 of a confining magnetic field, according to at least one embodiment. The plasma confinement system 400 may be an example of the plasma confinement system 100 described above with respect to FIG. 1A. The plasma confinement system 400 can include a plasma confinement device 404, represented here in sectional view. The plasma confinement system 400 can also include a particle injector 406 and a controller 410. The particle injector 406 may be an example of particle injector 106 of FIG. 1A.

Similar to FIG. 2, a magnetically confined plasma in the plasma confinement device 404 may be suspended in a region of closed magnetic flux defined by a separatrix 402, creating a confinement region, which can in turn include a core plasma region (e.g., core plasma region 102 of FIG. 1A). A characteristic region 408 of the confining magnetic field may be generated at a suitable location within the confinement region. The characteristic region 408 may be created close enough to the particle injector to allow for a quantity of particles to be deposited at or inside the characteristic region 408 and generate a sufficient density gradient to support the formation of a transport barrier (TB). This deposition can be accomplished by having a substantial quantity of neutral particles from the injector ionize at the position of the characteristic region or inside the characteristic region. Again, “inside” the characteristic region can refer to a region closer to the core of the plasma, with lower minor radius than the characteristic region 408.

The controller 410 may be any suitable controller or control system configured to operate particle injector 406. The controller 410 can include one or more processors and one or more memories configured to store computer-executable instructions that may cause the particle injector 406 to inject quantities of particles into the confinement region (e.g., the characteristic region 408 or inside it) of the confined plasma in the plasma confinement device 404. The controller 410 may be configured to perform any suitable number of operations to perform the techniques of this disclosure. In some embodiments, the controller 410 may be configured to receive one or more signals from one or more other components (e.g., sensors, probes, detectors, power supplies, etc.) of the plasma confinement system 400. The controller 410 may be configured to use the received signals to modify one or more operations under its control. For example, the controller 410 may receive a signal corresponding to a measured gradient (e.g., a temperature gradient) at a location (e.g., the characteristic region 408). The signal may indicate that a formed TB is weakening and that additional particles should be injected to sustain the TB. Based on the signal, the controller 410 may respond and inject an additional quantity of particles to sustain the TB. Other parameters (e.g., the type of particles to be injected, the duration between injections, etc.) may be similarly modified based on received signals.

In some embodiments, the controller 410 may also be configured to output control signals to one or more other components of the plasma confinement system 400. For example, the controller 410 may send a signal to control the current used to establish the characteristic region (e.g., characteristic region 408).

FIG. 5 is a plot 500 depicting example operating modes of a plasma confinement device. The plot depicts arbitrary plasma pressure versus normalized radius r/a, where r is the radial coordinate from the center of the toroidal section of the plasma confinement device and a is the minor radius (e.g., minor radius 116 of FIG. 1A). As discussed previously, tokamaks may operate in a high-confinement mode (H-mode) 504 that results in an internal transport barrier (ITB) 508 as well as an edge TB 510. The H-mode may be distinguished from a low-confinement mode 506 (L-mode) that exists before the confined plasma is strongly heated. The transition from L-mode to H-mode is generally thought to result from the suppression of turbulence in the plasma. The ITB in the H-mode may define an interior “core” region 502 of the plasma where sufficient temperature and density are achieved to support the fusion process. The edge TB 510 in the H-mode is typically close to the interior wall of the reactor, where the magnetic field lines are open and particle flux is not confined and may impinge the walls and other structures.

As depicted in FIG. 5, the ITB 508 may exist in an interior region relatively far from the wall of the plasma confinement device (represented by r/a=1). The location of the ITB 508 limits the size of the core region 502. In addition, if the ITB 508 were to be generated in a characteristic region of the magnetic field (e.g., characteristic region 108 of FIG. 1A), the location of ITB 508 may be too far from a particle injector for the particles to reach the location intact.

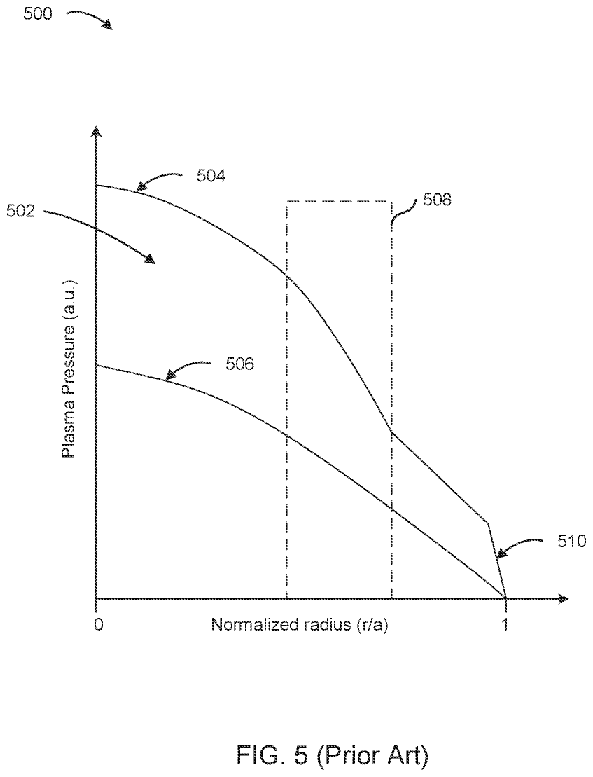

FIG. 6 is another plot 600 depicting an example temperature gradient for a confined plasma exhibiting a generated transport barrier 608, according to at least one embodiment. The plot 600 depicts ion temperature 602 (in arbitrary units) versus the normalized radius. Typical values for ion temperature and electron temperature of current confinement regimes are approximately 17 keV and 7 keV respectively; higher values, particularly of the ion temperature, may be achievable in devices with improved confinement according to embodiments of the present disclosure.

The gradients for the ion temperature 602 may occur in a region corresponding to transport barrier 608. The transport barrier 608 may occur at a characteristic region of the magnetic field confining the plasma, which may be similar to characteristic regions described herein. The transport barrier 608 may be located at a distance 606 from the interior wall of a plasma confinement device. The distance 606 may be such that the gradients are formed at a suitable location to be sustained by the injection of particles.

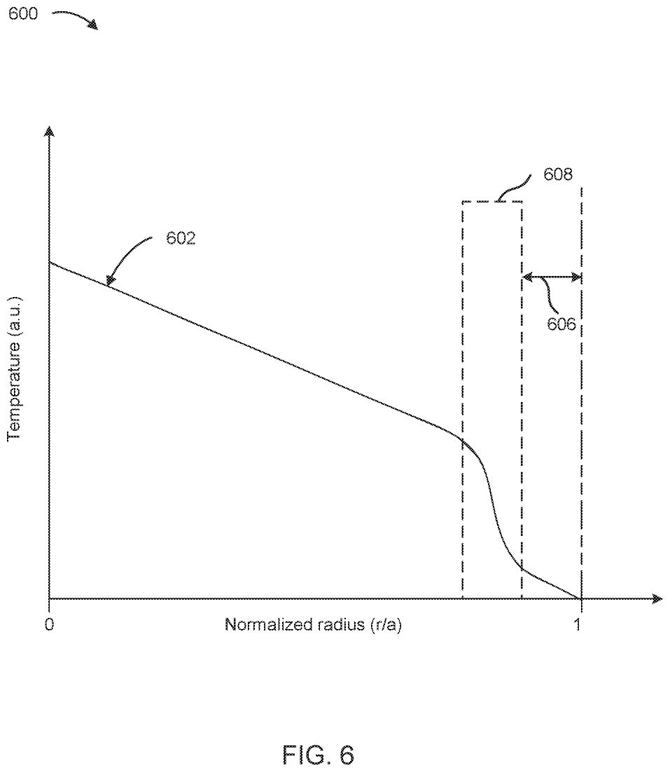

FIG. 7 is a simplified diagram of an example method 700 for generating a characteristic region in the magnetic field confining a plasma, according to at least one embodiment. The method 700 may be performed by one or more components of a plasma confinement system (e.g., plasma confinement system 100 of FIG. 1A, plasma confinement system 400 of FIG. 4). The method 700 is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. For example, the controller 410 of FIG. 4, or a similar computing system within the plasma confinement system. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement the processes.

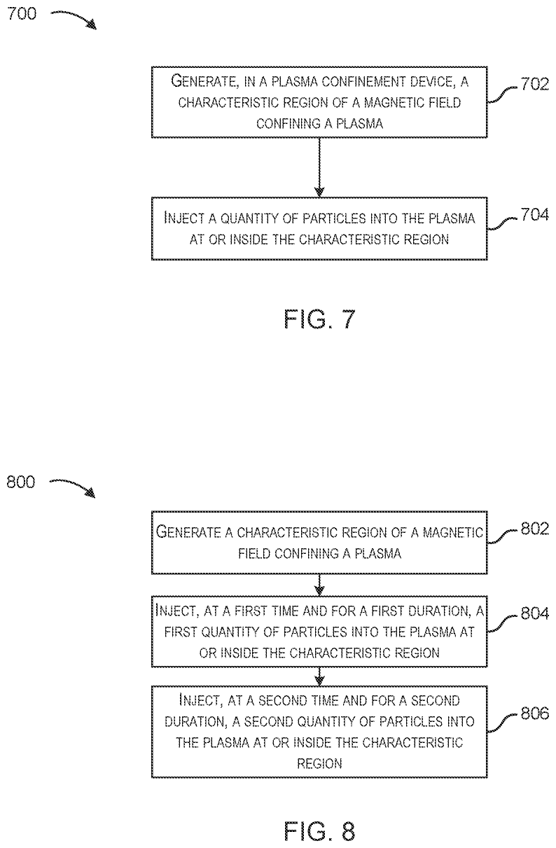

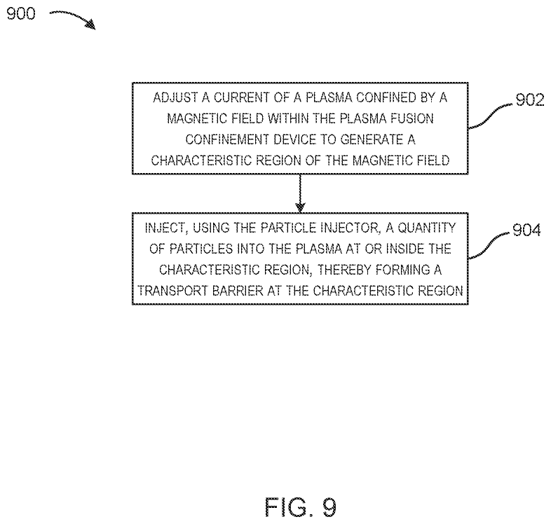

Some or all of the method 700 (or any other processes described herein, or variations, and/or combinations thereof, e.g., method 800 of FIG. 8, method 900 of FIG. 9) may be performed under the control of one or more computer systems (e.g., controller 410 of FIG. 4) configured with executable instructions and may be implemented as code (e.g., executable instructions, one or more computer programs, or one or more applications) executing collectively on one or more processors, by hardware or combinations thereof. The code may be stored on a computer-readable storage medium (e.g., one or more memories of a computer system), for example, in the form of a computer program comprising a plurality of instructions executable by one or more processors. The computer-readable storage medium may be non-transitory.

The method 700 may begin at block 702, where a characteristic region may be generated in a magnetic field confining a plasma. The magnetic field may be generated in the interior of a plasma confinement device (e.g., plasma confinement device 101 of FIG. 1A). The characteristic region may be characterized by a negative magnetic shear, a reduced magnetic shear, a large Shafranov shift, a particular flux surface shape, or other similar characteristic of the magnetic field or combinations of these characteristics. The characteristic region may be generated by creating a current in the plasma confined by the magnetic field. The current may be parallel or substantially parallel to the magnetic field at the location of the characteristic region. The current may be generated by one or more external coils that may inductively couple with the plasma, or by radio waves generated outside the plasma and absorbed in the characteristic region, or by neutral particle beams, or by other means known in the art.

At block 704, a quantity of particles may be injected at or inside the characteristic region generated at block 702. The particles may be injected by one or more particle injectors (e.g., particle injector 106 of FIG. 1A). The particles may include fusion fuel particles (e.g., deuterium, tritium), impurity particles (e.g., neon, other noble gases, carbon, silicon, etc.), or a combination of fuel particles and impurity particles. The quantity of particles may be in the form of a pellet (e.g., a cryogenic pellet) and may include more than one pellet. In some embodiments, the quantity of particles may include particles confined a compact toroid (e.g., a compact, magnetically confined plasma) that may be injected into the confined plasma of the plasma confinement device.

In some embodiments, injecting the quantity of particles may generate a transport barrier (TB). The TB may be generated at the location of the characteristic region. The combination of the increased density gradient due to the injected particles and the magnetic geometry (e.g., magnetic shear, Shafranov shift, etc.) at the characteristic region may suppress turbulent transport processes sufficiently to allow the formation of the TB. The TB may be characterized by large, stable gradients in the plasma parameters, including pressure, temperature, and density. The TB may be generated at a location that is about 90% of the minor radial distance (e.g., minor radius 116 of FIG. 1A) of the toroidal section of the plasma confinement device. Said another way, the TB may be formed at approximately 90% of the distance from the center of the confined plasma to the interior wall of the plasma confinement device. In other embodiments, the TB may be formed at different locations suitable for injection particles to initiate and sustain the TB. For example, the TB may be formed at approximately 70% of the minor radial distance or at approximately 80% of the minor radial distance.

As indicated above, the TB may be characterized by a large, stable gradient in the plasma pressure. For instance, a pressure gradient dp/dr exceeding a threshold value can indicate the generation of a TB when particles are injected at or into the characteristic region. As an example,

$$\frac{dp}{dr} > 5 \times \frac{p}{a}$$

can define the TB, where p is the plasma pressure, r is the radial coordinate, and a is the minor radius of the plasma confinement device. The factor of 5 can be characteristic of a sufficiently “large” pressure gradient to indicate a TB, although other values for this factor are contemplated. Prior to injecting the quantity of particles, the pressure gradient may be below the threshold value

$$( e . g . , \frac{dp}{dr} < 5 \times \frac{p}{a} ) .$$

After injecting the particles, the pressure gradient may exceed the threshold value

$$( e . g . , \frac{dp}{dr} > 5 \times \frac{p}{a} ) ,$$

thereby generating the TB at or inside the characteristic region.

It should be appreciated that the specific steps illustrated in FIG. 7 provide a particular method of generating a characteristic region of a magnetic field confining a plasma, according to an embodiment of the present invention. The individual steps illustrated in FIG. 7 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 8 is another simplified diagram of an example method 800 for initiating a transport barrier with a first quantity of particles and sustaining the transport barrier with a second quantity of particles, according to at least one embodiment. As with method 700 of FIG. 7, the method 800 may be performed by one or more components of a plasma confinement system (e.g., plasma confinement system 100 of FIG. 1A, plasma confinement system 400 of FIG. 4).

The method 800 may begin at block 802, where a characteristic region of a magnetic field confining a plasma is generated. The operations of block 802 may be similar to the operations of block 702 of FIG. 7.

At block 804, a first quantity of particles may be injected into the plasma and deposit in the plasma at the characteristic region or inside it. The particles may be injected by a particle injector (e.g., particle injector 106 of FIG. 1A), which may include a pellet injector, a neutral beam injector, a spheromak gun or other compact toroidal plasma injector, or similar device. The first quantity of particles may be impurity particles to initiate the formation of a transport barrier (TB) at or inside the characteristic region. Because impurity particles (e.g., particles with high Z number) may be better at initiating a TB, the first quantity of particles injected may include all or portion of impurity particles. The first quantity of particles may be injected at a first time and for a first duration. The first quantity of particles may be injected over the first duration (e.g., inject several pellets at one location, inject pellets at different toroidal locations along the confinement region). Injecting the particles over the first duration may define a time averaged rate of injection for the first quantity of particles. In some embodiments, the time averaged rate of injection may be based on an average for time periods different than the first duration.

At block 806, a second quantity of particles may be injected into the plasma and deposit in the plasma at the characteristic region or inside it. Similar to block 804, the second quantity of particles may be injected by a particle injector. The second quantity of particles may include fusion fuel particles (e.g., deuterium, tritium). The injection of the second quantity of particles may occur after the formation of a TB (e.g., a TB formed by the injection of the first quantity of particles). The second quantity of particles may be greater than, less than, or the same as the first quantity of particles, depending on the desired density to be enhanced at the characteristic region. For example, the first quantity of particles may be a relatively large quantity of impurity particles (e.g., a large pellet) to initiate the TB, while the second quantity of particles may be a relatively small quantity of fusion fuel to sustain the TB. The second quantity of particles may be injected for a second duration, which may define a time averaged rate of injection for the second quantity of particles. In some embodiments, the second duration may be greater than the first duration. For example, injecting a second quantity of fusion fuel particles to sustain a TB may occur over a much longer duration than the injection of the first quantity of particles to initiate the TB. The time averaged rate of particle injection for the second injection may be considerably less than the time averaged rate of particle injection for the first injection.

In some embodiments, both the first quantity of particles and the second quantity of particles can include impurity particles, fusion fuel particles, or any suitable combination of particles. For example, the first quantity of particles may include impurity particles while the second quantity of particles can include a mixture of impurity particles and fusion fuel particles. The first quantity of particles may be the same type of particles as the second quantity of particles. In some embodiments, the first quantity of particles can include a first fraction of fusion fuel particles (e.g., a fraction of the total quantity of particles in the first quantity), while the second quantity of particles can include a second fraction of fusion fuel particles. The second fraction may be greater than the first fraction.

In some embodiments, the quantities of particles may be injected by more than one particle injector. For example, for a toroidal confinement device, particle injection may occur at multiple locations around the torus of the device, to form a TB along the toroidal direction of the confined plasma.

It should be appreciated that the specific steps illustrated in FIG. 8 provide a particular method of injecting two quantities of particles at a characteristic region of a magnetic field confining a plasma, according to an embodiment of the present invention. Other sequences of steps may also be performed according to alternative embodiments. For example, alternative embodiments of the present invention may perform the steps outlined above in a different order. Moreover, the individual steps illustrated in FIG. 8 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 9 is another simplified diagram of an example method 900 for generating a transport barrier at a characteristic region of a magnetically confined plasma, according to at least one embodiment. The method 900 may be performed by one or more components of a plasma confinement system (e.g., plasma confinement system 100 of FIG. 1A, plasma confinement system 400 of FIG. 4). The plasma confinement system can include a plasma confinement device (e.g., a tokamak), a particle injector (or more than one particle injectors), and a controller that includes one or more processors and one or more memories that can store and execute instruction to perform the method 900.

The method 900 may begin at block 902 where a current in a plasma is adjusted to generate a characteristic region of a magnetic field. The plasma may be confined by the magnetic field within the plasma confinement device. The current may be adjusted by one or more control signals from the controller. The adjustment of the current may create the current parallel or substantially parallel to the magnetic field at the characteristic region.

Once the characteristic region is generated, particles may be injected into the plasma at the characteristic region, according to block 904. The injection of particles into the characteristic region may form a transport barrier at the characteristic region. The operations of block 904 may be similar to the operations described above for blocks 704 and 804 of FIGS. 7 and 8, respectively.

It should be appreciated that the specific steps illustrated in FIG. 9 provide a particular method of generating a transport barrier at a characteristic region of a magnetic field confining a plasma, according to an embodiment of the present invention. The individual steps illustrated in FIG. 9 may include multiple sub-steps that may be performed in various sequences as appropriate to the individual step. Furthermore, additional steps may be added or removed depending on the particular applications. One of ordinary skill in the art would recognize many variations, modifications, and alternatives.

A computing device may be incorporated as part of the previously described systems, such as a system plasma confinement system (e.g., plasma confinement system 100) for generating a characteristic region in a magnetic field and injecting a quantity of particles into the characteristic region. Computing devices may be useful for performing aspects of the previously described methods. For example, computing devices may be useful for controlling particle injection rates, injection times, injection duration, for the selection of particles (e.g., fusion fuel pellets, impurity pellets), for controlling the current in the plasma generating the characteristic region, for receiving signals corresponding to measurements of plasma parameters (e.g., temperature, pressure, etc.), and so on. An example computing device comprises hardware elements that may be electrically coupled via a bus (or may otherwise be in communication). The hardware elements may include one or more processors, including without limitation one or more general-purpose processors and/or one or more special-purpose processors (such as digital signal processing chips, graphics acceleration processors, video decoders, and/or the like); one or more input devices, which may include without limitation a mouse, a touchscreen, keyboard, remote control, voice input, and/or the like; and one or more output devices, which may include without limitation a display device, a printer, speaker, a servo, a linear actuator, a rotational actuator, etc.

The computing device may further include (and/or be in communication with) one or more non-transitory storage devices, which may comprise, without limitation, local and/or network accessible storage, and/or may include, without limitation, a disk drive, a drive array, an optical storage device, a solid-state storage device, such as a solid state drive (“SSD”), random access memory (“RAM”), and/or a read-only memory (“ROM”), which may be programmable, flash-updateable and/or the like. Such storage devices may be configured to implement any appropriate data stores, including without limitation, various file systems, database structures, and/or the like.

The computing device may also include a communications subsystem, which may include without limitation a modem, a network card (wireless or wired), an infrared communication device, a wireless communication device, and/or a chipset (such as a Bluetooth device, a Bluetooth Low Energy or BLE device, an 802.11 device, an 802.15.4 device, a WiFi device, a WiMax device, cellular communication device, etc.), a G.hn device, and/or the like. The communications subsystem may permit data to be exchanged with a network, other computer systems, and/or any other devices described herein. In many embodiments, the computing device will further comprise a working memory, which may include a RAM or ROM device, as described above.

The computing device also may comprise software elements, such as located within the working memory, including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the methods discussed above may be implemented as code and/or instructions executable by a computer (and/or a processor within a computer); in an aspect, then, such code and/or instructions may be used to configure and/or adapt a computer (or other device) to perform one or more operations in accordance with the described methods.

A set of these instructions and/or code may be stored on a non-transitory computer-readable storage medium, such as the non-transitory storage devices described above. In some cases, the storage medium may be incorporated within a computer system, such as the computing device described above. In other embodiments, the storage medium may be separate from a computer system (e.g., a removable medium, such as a compact disc, or a cloud- or network-based storage system), and/or provided in an installation package, such that the storage medium may be used to program, configure, and/or adapt a computer with the instructions/code stored thereon. These instructions may take the form of executable code, which is executable by the computing device or a component thereof and/or may take the form of source and/or installable code, which, upon compilation and/or installation on the computing device (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware may also be used, and/or particular elements may be implemented in hardware, software (including portable software, such as applets, etc.), or both. Further, connection to other computing devices such as network input/output devices may be employed.

As mentioned above, in one aspect, some embodiments may employ a computing device to perform methods in accordance with various embodiments. According to a set of embodiments, some or all of the procedures of such methods are performed by the computing device in response to a processor executing one or more sequences of one or more instructions (which may be incorporated into the operating system and/or other code, such as an application program) contained in the working memory (e.g., one or more memories). Such instructions may be read into the working memory from another computer-readable medium, such as one or more non-transitory storage devices. Merely by way of example, execution of the sequences of instructions contained in the working memory may cause the processor to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computing device, various computer-readable media may be involved in providing instructions/code to a processor for execution and/or may be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as a non-transitory storage device. Volatile media include, without limitation, dynamic memory, such as the working memory.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer may read instructions and/or code. Network-based and cloud-based storage systems may also be useful forms of computer-readable media.

Various forms of computer-readable media may be involved in carrying one or more sequences of one or more instructions to the processor for execution. Merely by way of example, the instructions may initially be carried on a magnetic disk and/or optical disc of a remote computer. A remote computer may load the instructions into its dynamic memory and send the instructions as signals over a transmission medium to be received and/or executed by the computing device.

The communications subsystem (and/or components thereof) generally will receive signals, and the bus then may carry the signals (and/or the data, instructions, etc. carried by the signals) to the working memory, from which the processor retrieves and executes the instructions. The instructions received by the working memory may optionally be stored on a non-transitory storage device either before or after execution by the processor.

It should further be understood that the components of computing device may be distributed. For example, some processing may be performed in one location using a first processor while other processing may be performed by another processor remote from the first processor. Optionally, systems described herein may include multiple independent processors that may exchange instructions or issue commands or provide data to one another. Other components of computing device may be similarly distributed. As such, a computing device may be interpreted as a distributed computing system that performs processing in multiple locations. In some instances, a computing device may be interpreted as a single computing device, such as a distinct laptop, desktop computer, or the like, depending on the context.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein, the singular forms “a,” “an,” and “the” include plural references unless the context clearly dictates otherwise.

It is also understood that the examples and embodiments described herein are for illustrative purposes only and that various modifications or changes in light thereof will be suggested to persons skilled in the art and are to be included within the spirit and purview of this application and scope of the appended claims, which follow.

1. A method, comprising:
generating, in a plasma confinement device, a characteristic region of a magnetic field confining a plasma; and
injecting a quantity of particles into the plasma at or inside the characteristic region thereby generating a transport barrier at or inside the characteristic region.

2. The method of claim 1, wherein the characteristic region is defined by: a region of negative magnetic shear in the magnetic field confining the plasma, a region of low magnetic shear in the magnetic filed confining the plasma, or a large Shafranov shift.

3.-4. (canceled)

5. The method of claim 1, wherein the characteristic region is defined by a particular shape of magnetic surfaces of the magnetic field confining the plasma or resonant magnetic perturbations of the magnetic field confining the plasma.

6. (canceled)

7. The method of claim 1, wherein the characteristic region is defined by a combination of magnetic shear, Shafranov shift, a shape of magnetic surfaces of the magnetic field confining the plasma, and resonant magnetic perturbations of the magnetic field.

8. The method of claim 1, wherein generating the characteristic region comprises generating a current in the plasma, the current parallel with the magnetic field at the characteristic region.

9. The method of claim 1, wherein the transport barrier is characterized by a pressure gradient dp/dr of the plasma exceeding a threshold value, wherein the threshold value is 5× p/a, wherein p is the plasma pressure, and wherein a is a minor radius of the plasma confinement device.

10. (canceled)

11. The method of claim 1, wherein the transport barrier is generated at a position between about 70% to about 90% of a minor radius of the plasma confinement device.

12.-13. (canceled)

14. The method of claim 1, wherein the quantity of particles comprises fusion fuel particles or impurity particles.

15. The method of claim 14, wherein the fusion fuel particles comprise deuterium or tritium.

16. (canceled)

17. The method of claim 14, wherein the impurity particles comprise at least one of the following species: carbon, silicon, a noble gas, or an element with atomic number Z less than 21.

18. A method, comprising:
generating a characteristic region of a magnetic field confining a plasma;
injecting, at a first time and for a first duration, a first quantity of particles into the plasma at or inside the characteristic region, thereby generating a transport barrier at or inside the characteristic region; and
injecting, at a second time and for a second duration, a second quantity of particles into the plasma at or inside the characteristic region.

19. The method of claim 18, wherein the characteristic region is defined by a region of negative magnetic shear in the magnetic field confining the plasma.

20.-24. (canceled)

25. The method of claim 18, wherein the first quantity of particles comprises at least a portion of impurity particles and wherein the second quantity of particles comprises impurity particles, fusion fuel particles, or a mixture of impurity particles and fusion fuel particles.

26.-28. (canceled)

29. The method of claim 18, wherein the time averaged rate of particle injection for the second quantity of particles is less than the time averaged rate of injection of the first quantity of particles.

30. The method of claim 18, wherein the first quantity of particles comprises a first fraction of fusion fuel particles and the second quantity of particles comprises a second fraction of fusion fuel particles, and wherein the second fraction is greater than the first fraction.

31. The method of claim 18, wherein the second duration is greater than the first duration.

32. A system, comprising:
a plasma confinement device;
a particle injector; and
a controller comprising:
one or more processors; and
one or more memories storing computer-executable instructions that, when executed with the one or more processors, cause the system to at least:
adjust a current of a plasma confined by a magnetic field within the plasma confinement device to generate a characteristic region of the magnetic field; and
inject, using the particle injector, a quantity of particles into the plasma at or inside the characteristic region, thereby forming a transport barrier at or inside the characteristic region.

33. The system of claim 32, wherein the plasma confinement device is one of a tokamak device, a stellarator, or a toroidal pinch device.

34. The system of claim 32, wherein the particle injector is configured to inject the quantity of particles as high velocity pellets, wherein the quantity of particles comprises a portion of cryogenically frozen pellets.

35. (canceled)

36. The system of claim 32, wherein the particle injector is configured to inject the quantity of particles as a magnetically confined plasma, wherein the magnetically confined plasma comprises a compact toroid.

37.-42. (canceled)
